(19) United States
(12) Patent Application Publication
(10) Pub. No.: US 2009/0202059 A1
(43) Pub. Date: Aug. 13, 2009

(54) Memo Service for Telecommunications Network

(76) Inventor: Ranjan Sharma, New Albany, OH (US)

Correspondence Address: FAY SHARPE/LUCENT, 1228 Euclid Avenue, 5th Floor, The Halle Building, Cleveland, OH, 44115-1843, US

(21) Appl. No.: 12/029,727

(22) Filed: Feb. 12, 2008

(51) Int. Cl. H04M 3/42

(52) U.S. Cl. 379/201.01

(57) ABSTRACT

A method is provided in a telecommunications network (30) for supplying a first party (10) personal information about a second party (40) prior to completing establishment of a call between the parties over the network (30). The method includes: storing a number of records for the first party (10) in a location (24) within the network (30), each record associating particular personal information related to a particular second party with an identifier corresponding to that particular second party; when a call is processed within the network (30) for the first party (10), checking if an identifier of the second party (40) to the call being processed matches an identifier in the location where the records are stored for the first party (10); and, if the identifier of the second party (40) in the call being processed within the network (30) does indeed match an identifier in the location where the records are stored for the first party (10), then playing an announcement to the first party (10) including the personal information associated in the corresponding record with the matching identifier, said announcement being played to the first party (10) prior to establishment of the call between the parties.

### FIELD

The present inventive subject matter relates to the art of telephony. Particular application is found in conjunction with certain types of telecommunication networks and/or user equipment (UE), and the specification makes particular reference thereto. However, it is to be appreciated that aspects of the present inventive subject matter are also amenable to other like networks, devices and/or applications.

### BACKGROUND

Wireless and/or landline telecommunication networks are generally well known in the art and commonly used to provide telephony and/or other telecommunication services to a variety of subscribers or end users. As can be appreciate, telephony provides a convenient means of communication for end users transacting business as well as individuals making social calls. In various situations, it is common for one or both parties to a telephone call (i.e., the calling party and/or the called party) to want some personal information or facts about the other party prior to engaging in a conversation with them. For example, the party desiring the information may want to use the information in the ensuing conversation in order to avoid embarrassment, foster a sense of familiarity, etc. when the particular party desiring the information may not otherwise be able to recall the information from their own memory. Examples of such personal information or facts regarding a second party that a first party may desire include but are not limited to: the second party's alias or nickname, the names and/or ages of the second party's family members, the names of the second party's business partners and//or associates, the second party's birthday, wedding anniversary, and/or other dates of interest, the second party's address, business and/or customer relationship information related to the second party, etc. Other information or facts that the first party may desire can relate to events significant to the second party, e.g., that the second party recently vacationed or is about to vacation at a particular location. By being reminded of such personal information and/or fact about the second party just prior to a conversation with the second party, the first party is able to engage in the ensuing conversation, e.g., on a more personal and/or familiar level—i.e., unencumbered by the risk of embarrassment due to forgetting or misremembering significant personal details about the second party.

For a limited number of close friends, immediate family and/or other significant relationships, many people are able to remember and/or recall personal information and/or facts about the party in question when desired, e.g., such as when making or receiving a telephone call thereto or therefrom, respectively. However, for many relationships (e.g., such as casual acquaintances and/or vast multitudes of business contacts), an individual simply cannot remember and/or recall all the personal information and/or facts associated with every party. Accordingly, memory aids are commonly employed to record the pertinent information and/or facts about various contacts. For example, the personal information and/or facts about various contacts may be maintained in a personal digital assistant (PDA), a Rolodex® device or other conventional address book, or even a computer database (DB). In particular, individuals often employ commercially available computer programs or applications (e.g., such Microsoft® Office Outlook®) running on their laptop or desktop computers to keep track of personal information and/or facts associated with various contacts. In larger commercial applications, e.g., such as a call center, Customer Relationship Management (CRM) portals are commonly used to maintain customer relationship information about various customers serviced by the call center.

While generally useful, the foregoing memory aids have various drawbacks and/or limitations. In particular, CRM portals are generally not practical for use by individuals, e.g., due to the expense and/or inability of ordinary individuals to readily access suitable resources (i.e., hardware, software, etc.) commonly used to implement conventional CRM portals. Additionally, when employing other traditional memory aids of the type described above, an individual commonly has to manually employ the device (i.e., the computer, PDA, Rolodex® device, etc.) to look-up the desired contact information and/or personal facts, e.g., prior to placing a telephone call. Not only does this involve an extra step on the part of the calling party, the use of such memory aids by the called party is typically not convenient, e.g., because the called party may not know the identity of the calling party, and even if the called party does know the identity of the calling party (e.g., via caller ID), the called party may not have sufficient time to access the memory aid prior to having to answer the incoming call and/or engage in conversation with the calling party.

Still other problems can be encountered using traditional memory aids of the type alluded to above. For example, the above mentioned memory aid devices and the like which are implemented at the end user location may at times be inaccessible when desired, i.e., when making or receiving a telephone call. For example, the device may become lost or otherwise misplaced, and therefore, it cannot adequately serve its intended purpose insomuch as it is unavailable to the end user. Another drawback is that over time some memory aid devices may become obsolete, and the synchronization and/or transfer of personal contact information to next generation devices may not be supported or easily accomplished.

Accordingly, a new and improved method and/or system for providing a first party to a telephone call personal information and/or facts about a second party to the call prior to connecting the two parties is disclosed that overcomes the above-referenced problems and others.

### SUMMARY

In accordance with one embodiment, a method is provided in a telecommunications network for supplying a first party personal information about a second party prior to completing establishment of a call between the parties over the network. The method includes: storing a number of records for the first party in a location within the network, each record associating particular personal information related to a particular second party with an identifier corresponding to that particular second party; when a call is processed within the network for the first party, checking if an identifier of the second party to the call being processed matches an identifier in the location where the records are stored for the first party; and, if the identifier of the second party in the call being processed within the network does indeed match an identifier in the location where the records are stored for the first party, then playing an announcement to the first party including the personal information associated in the corresponding record with the matching identifier, the announcement being played to the first party prior to establishment of the call between the parties.

In accordance with another embodiment, a system is provided in a telecommunications network for supplying a first party personal information about a second party prior to completing establishment of a call between the parties over the network. The system includes: means for storing a number of records for the first party in a location within the network, each record associating particular personal information related to a particular second party with an identifier corresponding to that particular second party; when a call is processed within the network for the first party, means for checking if an identifier of the second party to the call being processed matches an identifier in the location where the records are stored for the first party; and, means for playing an announcement to the first party including the personal information associated in the corresponding record containing the matching identifier, if the identifier of the second party in the call being processed within the network does indeed match an identifier in the location where the records are stored for the first party, the announcement being played to the first party prior to establishment of the call between the parties

Numerous advantages and benefits of the inventive subject matter disclosed herein will become apparent to those of ordinary skill in the art upon reading and understanding the present specification.

### BRIEF DESCRIPTION OF THE DRAWINGS

The inventive subject matter may take form in various components and arrangements of components, and in various steps and arrangements of steps. The drawings are only for purposes of illustrating preferred embodiments and are not to be construed as limiting. Further, it is to be appreciated that the drawings are not to scale.

FIG. 1 is a block diagram illustrating an exemplary network configuration which may be suitably utilized for carrying out a provisioning phase of operation for the presently disclosed Phone Notes Service (PNS).

FIG. 2 is post and rail diagram illustrating an exemplary call flow for the provisioning phase of PNS operation.

FIG. 3 is a block diagram illustrating an exemplary network configuration which may be suitably utilized for carrying out an execution phase of operation for the presently disclosed PNS.

FIG. 4 is post and rail diagram illustrating an exemplary call flow for the execution phase of PNS operation, wherein the subscriber is the called party.

FIG. 5 is post and rail diagram illustrating an exemplary call flow for the execution phase of PNS operation, wherein the subscriber is the calling party.

FIG. 6 is a post and rail diagram illustrating an exemplary call flow for the execution phase of PNS operation, wherein both the calling and called parties are subscribers.

FIG. 7 is a block diagram illustrating the 3GPP/3GPP2 harmonized architecture for IMS which may be suitably utilized for practicing aspects of the present inventive subject matter.

FIGS. 8A-8C is post and rail diagram illustrating an exemplary call flow for the execution phase of operation of the PNS when implemented within the IMS, wherein the subscriber is the called party.

### DETAILED DESCRIPTION OF PREFERRED EMBODIMENTS

For clarity and simplicity, the present specification shall refer to structural and/or functional elements, relevant communication standards, protocols and/or services, and other components that are commonly known in the art without further detailed explanation as to their configuration or operation except to the extent they have been modified or altered in accordance with and/or to accommodate the preferred embodiment(s) presented herein.

Generally, the present specification describes a method and/or system in which a telecommunications service, referred to nominally herein as the Phone Notes Service (PNS), is provided to one or more subscribers, e.g., individuals or other such end users. Suitably, the PNS is implemented so as to be available to either or both the calling party and the called party, provided of course that the respective party is a valid subscriber to the service.

More specifically, the PNS is supported within a suitable telecommunications network, e.g., at the called party serving node (i.e., the call terminating side), the calling party serving node (i.e., the call originating side), and/or elsewhere. In one exemplary embodiment, the PNS is implemented in a network supporting an Internet Protocol (IP) Multimedia Subsystem (IMS) as described later herein. However, more generally, the PNS is equally applicable to and/or may similarly be provided in pre-IMS and/or other wireless networks as well as landline networks or some suitable combination thereof.

In short, the PNS permits a subscriber (i.e., a first party) to associate one or more “notes” or “memos” with one or more designated telephone numbers or other like addresses belonging to selected second parties. Suitably, the notes or memos are created by the subscriber and may contain, e.g., personal information and/or facts about a particular second party to which the designated telephone number belongs. In particular, examples of suitable personal information and/or facts contained in the notes or memos include but are not limited to: the second party's alias or nickname, the names and/or ages of the second party's family members, the names of the second party's business partners and//or associates, the second party's birthday, wedding anniversary, and/or other dates of interest, the second party's address, business and/or customer relationship information related to the second party, etc. Other suitable personal information or facts may relate to events significant to the second party, e.g., that the second party recently vacationed or is about to vacation at a particular location, that the second party or a family member of the second party is about to graduate or recently graduated from a particular school, that the second party is about to have or recently had a child, etc.

Accordingly, when the subscriber receives a call from a designated telephone number having a corresponding note or memo associated therewith, the corresponding note or memo is delivered to the subscriber prior to connecting the calling party with the subscriber. Similarly, when the subscriber places a call to a designated telephone number having a corresponding note or memo associated therewith, the corresponding note or memo is delivered to the subscriber prior to connecting the subscriber with the called party. In this way, the subscriber (regardless of whether they are the calling or called party) is reminded by the delivered note and/or memo of the personal information and/or facts about the other party to the call prior to the subscriber having to engage in conversation with the other party. Moreover, implementing the PNS in the manner described herein alleviates the problems associated with other traditional memory aids, e.g., as described in the Background section above.

In practice, the PNS is optionally implemented in two phases, referred to nominally herein as the provisioning phase and execution phase, respectively. In the provisioning phase, a subscriber utilizes the PNS to create one or more desired notes and/or memos and associate them with one or more designated telephone numbers. Thereafter, in the execution phase, the PNS controls and/or executes delivery of the notes and/or memos to the subscriber.

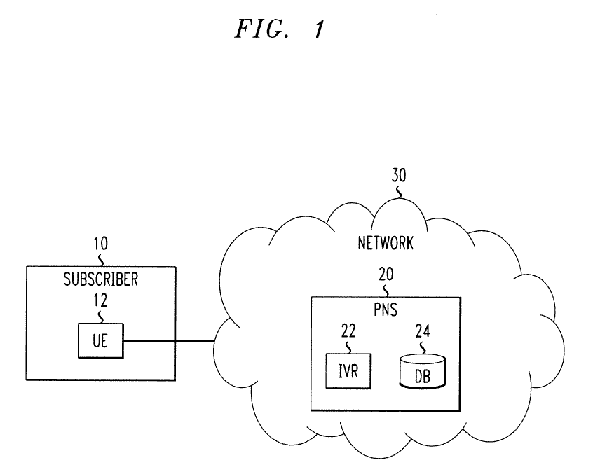

FIG. 1 illustrates an exemplary network configuration suitable for carrying out the provisioning phase of the PNS operation. As shown, the subscriber 10 selectively employs an appropriate end user device or user equipment (UE) 12 (e.g., such as a telephone) to access the PNS 20 via a suitable telecommunications network 30, e.g., a wireless network or a landline network or some combination thereof. As can be appreciated by persons of ordinary skill in the art, during the provisioning phase, the UE 12 is operatively connect to the network 30 in the usual manner so as to selectively permit the later described interaction and/or communication between the subscriber 10 and the PNS 20. For example, in order to access the PNS 20 to engaging in the provisioning phase of its operation, the subscriber 10 optionally dials a prescribed telephone number or feature code or otherwise enters an appropriate input using the UE 12. Accordingly, the network 30 operatively connects the subscriber 10 to the PNS 20 so that the subscriber 10 may suitably provision the service as desired, i.e., so that the subscribe 10 may suitably create and/or otherwise manage their various notes and/or memos.

In the illustrated embodiment, the PNS 20 is optionally equipped with or otherwise has access to an interactive voice response (IVR) unit 22 that is employed to facilitate the interaction between the subscriber 10 and the PNS 20. Additionally, the PNS 20 is also optionally equipped with or otherwise has access to a database (DB) 24 or other like storage location in which a subscriber's notes and/or memos are saved and/or otherwise maintained. Of course, it will be appreciated by persons of ordinary skill in the art that the IVR unit 22 is not the only possible means that may be employed to provide for the aforementioned subscriber/PNS interaction. For example, other optional embodiments may employ methods and/or means for provisioning the PNS 20 that include but are not limited to: SMS (Short Message Service) text provisioning, a web provisioning and a WAP provisioning method, calling a CSR to enter this data on behalf of the subscriber, etc.

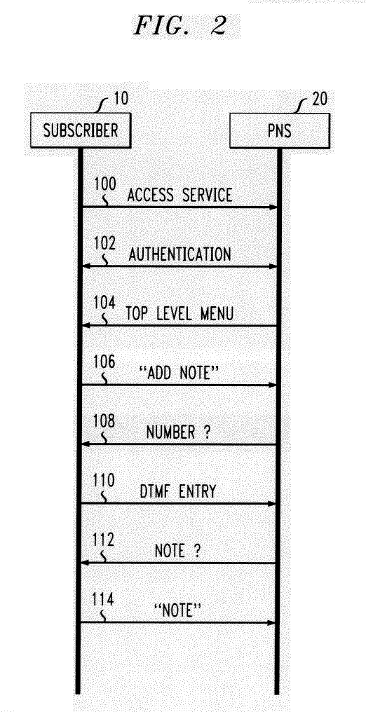

FIG. 2 illustrates an exemplary interaction between the subscriber 10 and the PNS 20 during the provisioning phase operation of the PNS 20, in which the subscriber 10 creates a new note or memo that is to be associated with a designated telephone number. As shown in this example, the provisioning phase operation begins at step 100 with the subscriber 10 accessing the PNS 20. In practice, step 100 is optionally carried out by the subscriber 10 using the UE 12 to place a call to the IVR unit 22, e.g., by dialing the prescribed telephone number or feature code or otherwise entering the appropriate input. At step 102, the subscriber 10 is authenticated. For example, the subscriber 10 may optionally be prompted by the IVR unit 22 to enter a password, user ID and/or other authentication credentials. Optionally, the PNS 20 may employ automatic number identification (ANI) or another like service or feature to determine the identity of the subscriber 10 and/or the UE 12. In any event, upon the subscriber 10 submitting their authentication credentials and/or otherwise complying with the request therefor, the supplied credentials are verified by the PNS 20 or a suitable adjunct to authenticate the subscriber 10.

Assuming the subscriber 10 has been properly authenticated, then at step 104, the subscriber 10 is optionally present (e.g., via the IVR unit 22) a menu of options, i.e., a “top level” menu, from which one or more may be selected by the subscriber 10. The top level menu optionally includes, e.g., an option to create and/or add a new note or memo as well as options to delete, edit and/or otherwise manage the subscriber's existing notes and/or memos.

In the illustrated example, at step 106, the subscriber 10 selects the option from the top level menu to add a new note or memo. Accordingly, at step 108, the PNS 20 prompts the subscriber 10 (e.g., via the IVR unit 22) to enter a telephone number or other like address that the subscriber desires to have associated with the new note or memo being created. In response to the prompt, at step 110, the subscriber 10 employs the UE 12 to input and/or otherwise submit a desired telephone number to the PSN 20, e.g., using a dual tone multi-frequency (DTMF) entry. As shown in FIG. 2 at step 112, after receiving the telephone number submitted by the subscriber 10, the PNS 20 then prompts the subscriber 10 (e.g., via the IVR unit 22) to enter the desired note or memo that is to be associated with the particular telephone number.

Suitably, in response to the prompt provided in step 112, the subscriber 10, at step 114, enters and/or otherwise submits to the PNS 20, the note or memo they desire to have associated with the previously provided telephone number. For example, via the UE 12, the subscriber 10 optionally speaks or recites the note or memo which is in turn recorded or otherwise captured by the PNS 20, e.g., in a suitable audio file format.

Having received the telephone number and associate note or memo, the PNS 20 stores the pertinent data and/or information in the DB 24 for the subscriber 10. As can be appreciated, the DB 24 is suitably equipped to store multiple entries for a plurality of similar subscribers. Accordingly, the DB 24 is optionally keyed to particular subscribers by a corresponding subscriber or user IDs, e.g., which may be the device ID of the UE 12 (i.e., an MSISDN (Mobile Subscriber Integrated Services Digital Network Number), a SIP (Session Initiation Protocol) or other URI (Uniform Resource Identifier), telephone number, etc.).

Conceptually, the subscriber or user data in the DB 24 optionally takes the following form:

User ID: (123) 456-7890

| Number | Note/Memo |
|---|---|
| 112-2334 | Audio data or file for note N1 (e.g., “Alice, spouse Bob, |
| | skiing vacation on December 4^{th}”) |
| 221-1223 | Audio data or file for note N2 (e.g., “John, spouse Jane, child |
| | Mark, pre-schooler, turns 4 on January 5^{th}”) |
| . . . | . . . |
| 221-3221 | Audio data or file for note n (e.g., “Mike, CEO of ABC |
| | Corporation, member of XYZ Golf Club, purchased 24 units |
| | of product last quarter”) |

In the illustrated example, the user ID identifies the subsequent records as belonging to a particular subscriber—in this example, the subscriber having the telephone number (123) 456-7890. Additionally, each record associates a particular telephone number (e.g., 112-2334, 221-1223, 221-3221, etc.) with a particular note or memo (e.g., note N1, note N2, etc.). Of course, optionally, there may be multiple entries or records having the same telephone number or there may otherwise be multiple notes associate with any one given telephone number. Likewise, any one particular note may be associated with any one or more telephone numbers. In any event, as can be appreciated, in the provisioning phase of operation, the subscriber 10 interacts with the PNS 20 to build and/or otherwise manage the foregoing data and/or information in the DB 24, i.e., by the subscriber 10 providing the PNS 20 with the designated telephone numbers and corresponding notes and/or memos as previously described.

It is to be appreciated that the PNS 20 plays announcements to subscribers during the call establishment phase. While the call is being established, there are timers active in the network that apply to the call establishment phase. Accordingly, the sum total of time spent in playing announcements to the calling and/or the called party generally may not exceed such timers, unless specific measures are taken by the PNS to reset such network timers periodically. Accordingly, in one optional embodiment, it is envisaged that this timer issue is circumvented in the provisioning phase by ensuring that the sum total of announcements to be played specific to an MSISDN does not exceed a pre-specified and/or configurable time. For example, in practice, this would be around 10 seconds for each half of the call.

Accordingly, during the execution phase of operation, when the subscriber 10 receives a call from or make a call to a designated telephone number list in the DB 24 under their user ID, then the PNS 20 delivers the associated note or memo to the subscriber 10 prior to connecting the call with the other party, i.e., the party to whom the designated telephone number belongs. For example, assume that the subscriber 10 (having telephone number (123) 456-7890) makes a telephone call to or receives a telephone call from the number 112-2334, i.e., the telephone number belonging to Alice in this case. Suitably, the PNS 20 intercepts the call upon recognizing that the originating (i.e., (123) 456-7890) identifies the subscriber 10. Accordingly, the PNS 20 quires the DB 24 under the subscribers user ID to determine if the called number or calling number (i.e., 112-2334) is listed therein. In this example, the called or calling number is in fact listed in the records under the subscriber's user ID. Therefore, prior to connecting the call between the subscriber 10 and Alice, the PNS 20 plays and/or otherwise delivers the note in the DB 24 associated with the designated number (i.e., note N1 in this case) to the subscriber 10. In this manner, before having to engage in conversation with Alice, the subscriber 10 is reminded that Alice's spouse is Bob and she had or has planned a ski vacation on December 4^{th}.

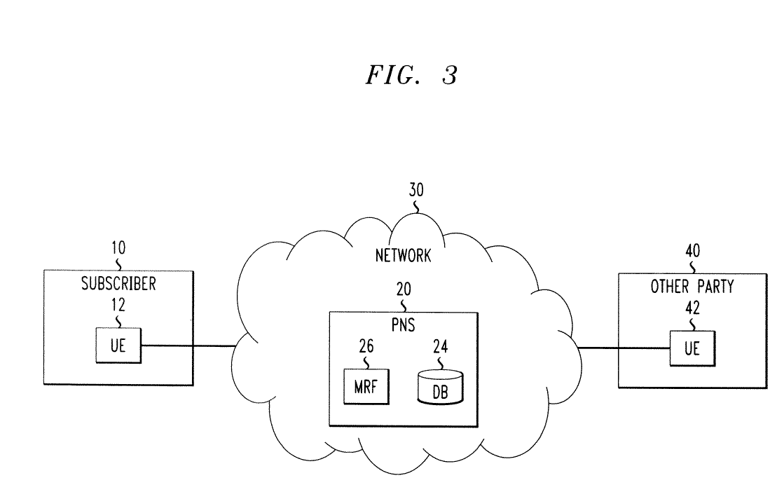

With reference now to FIG. 3, there is illustrated an exemplary network configuration suitable for carrying out the execution phase of the PNS operation. As shown, the subscriber 10 again employs the UE 12 to selectively make and/or receive a telephone call over the network 30 which supports the PNS 20. Also illustrated in FIG. 3 is another party 40 to whom or from whom the telephone call is made or received as the case may be. As shown in this example, the other party 40 employs UE 42 (e.g., a telephone or other suitable end user equipment) to participate in the call. As can be appreciated by persons of ordinary skill in the art, during the execution phase, the UE 12 and the UE 42 is operatively connect to the network 30 in the usual manner so as to selectively permit the later described interaction and/or communication between the subscriber 10, the other party 40 and the PNS 20.

Also shown in FIG. 3 is a Media Resource Function (MRF) 26 that is utilized by the PNS 20 for playback and/or delivery of selected notes and/or memos to the subscriber 10. Suitably, the MRF 26 is employed when the PNS 20 is implemented in IMS applications. However, in other applications and/or network environments other similar functional and/or physical elements and/or components may suitably be employed in like fashion.

In any event, during the execution phase, the subscriber 10 may either be the calling party or the called party, and consequently, the other party 40 takes the opposing position. Accordingly, execution phase operation of the PNS 20 will now be described with reference to each of these two cases.

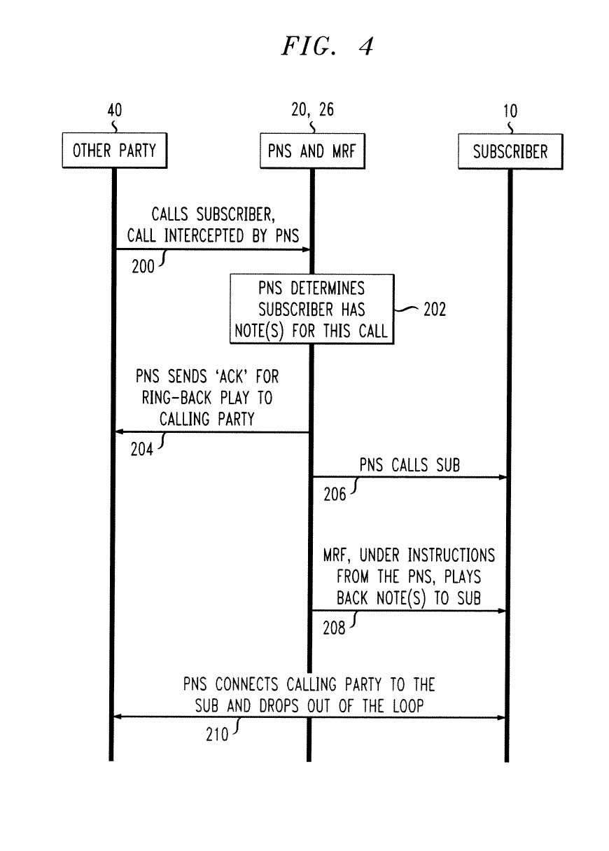

FIG. 4 illustrates an example of the execution phase of the PNS operation in the case where the subscriber 10 is the called party and the other party 40 is the calling party. As shown, the execution phase of the PNS operation in this case begins at step 200 with the calling party 40 placing a call to the subscriber 10 over the network 30. For example, the call may be placed in the usual fashion by the calling party dialing the subscriber's telephone number via the UE 42.

At step 202, the PNS 20 intercepts the call upon recognizing that the called or terminating telephone number belongs to and/or otherwise identifies the subscriber 10. Accordingly, the PNS 20 quires the DB 24 under the subscriber's user ID to determine if the calling number or originating number is listed therein. In this example, it will be presumed that the calling or originating number is in fact listed in the records under the subscriber's user ID. Therefore, at step 204, the PNS 20 returns an “acknowledge” message or other suitable signal to provide ring-back to the calling party 40 while awaiting completion of the call processing.

Meanwhile, at step 206, the PNS 20 places a call to the subscriber 10. When the subscriber 10 answers the call (e.g., using the UE 12), then at step 208, the PNS 20 plays-back or otherwise delivers (e.g., using the MRF 26) the note or memo stored in the DB 24 that is associated with the corresponding calling or originating number. Suitably, after playback and/or delivery of the note or memo has been completed, then at step 210 the PNS 20 connects the calling party 40 to the subscriber 10 and drops out of the loop leaving the parties free to converse as desired.

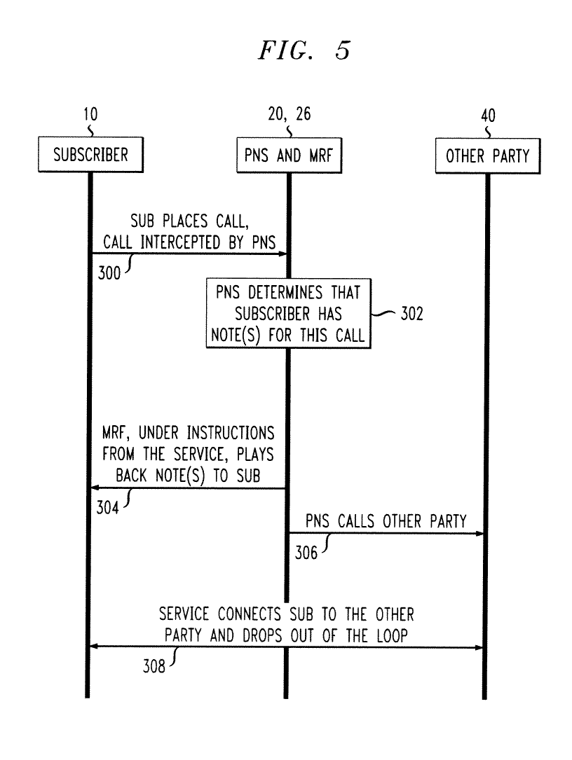

FIG. 5 illustrates an example of the execution phase of the PNS operation in the case where the subscriber 10 is the calling party and the other party 40 is the called party. As shown, the execution phase of the PNS operation in this case begins at step 300 with the subscriber 10 placing a call to the called party 40 over the network 30. For example, the call may be placed in the usual fashion by the subscriber 10 dialing the called party's telephone number via the UE 12.

At step 302, the PNS 20 intercepts the call upon recognizing that the calling or originating telephone number belongs to and/or otherwise identifies the subscriber 10. Accordingly, the PNS 20 quires the DB 24 under the subscriber's user ID to determine if the called number or terminating number is listed therein. In this example, it will be presumed that the called or terminating number is in fact listed in the records under the subscriber's user ID. Therefore, at step 304, the PNS 20 plays-back or otherwise delivers (e.g., using the MRF 26) the note or memo stored in the DB 24 that is associated with the corresponding called or terminating number.

Suitably, after playback and/or delivery of the note or memo has been completed, then at step 306, the PNS 20 places a call to the called party 40. When the called party 40 answers the call (e.g., using the UE 42), then at step 308, the PNS 20 connects the subscriber 10 to the called party 40 and drops out of the loop leaving the parties free to converse as desired.

Of course, in practice, there may be instances in which both the called party and the calling party are subscribers to the PNS 20. Accordingly, in such cases, as can be appreciated by persons of ordinary skill in the art, a combination of the steps described with reference to FIGS. 4 and 5 may optionally be employed to provide the service to both parties. However, providing for ring-back to the calling party subscriber may optionally be omitted insomuch as they would be receiving their own notes or memos during this time.

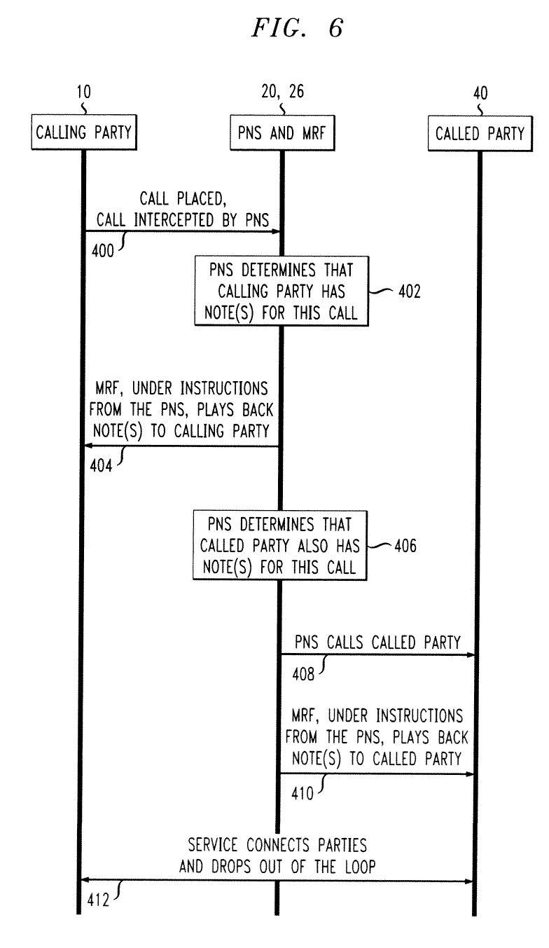

FIG. 6 illustrates an example of the execution phase of the PNS operation in the case where the calling party (i.e., party 10) and the called party (i.e., party 40) are both subscribers to the PNS. As shown, the execution phase of the PNS operation in this case begins at step 400 with the subscriber 10 placing a call to the called party 40 (also a subscriber) over the network 30. For example, the call may be placed in the usual fashion by the subscriber 10 dialing the called party's telephone number via the UE 12.

At step 402, the PNS 20 intercepts the call upon recognizing that the calling or originating telephone number belongs to and/or otherwise identifies the subscriber 10. Accordingly, the PNS 20 quires the DB 24 under the subscriber's user ID to determine if the called number or terminating number is listed therein. In this example, it will be presumed that the called or terminating number is in fact listed in the records under the subscriber's user ID. Therefore, at step 404, the PNS 20 plays-back or otherwise delivers (e.g., using the MRF 26) the note or memo stored in the DB 24 that is associated with the corresponding called or terminating number.

Meanwhile, at step 406, the PNS 20 additionally recognizes that the called or terminating telephone number also belongs to and/or otherwise identifies a subscriber (i.e., party 40 in this instance). Accordingly, the PNS 20 quires the DB 24 under the subscriber's user ID (i.e., the user ID for party 40) to determine if the calling number or originating number is listed therein. In this example, it will be presumed that the calling or originating number is in fact listed in the records under the user ID for the party 40. Therefore, at step 408, the PNS 20 calls the called party 40, and at step 410, the PNS 20 plays-back or otherwise delivers (e.g., using the MRF 26) the note or memo stored in the DB 24 that is associated with the corresponding calling or originating number.

Suitably, after playback and/or delivery of the respective notes or memos to the respective parties 10 and 40 has been completed, then at step 412, the PNS 20 connects the subscriber 10 to the called party 40 and drops out of the loop leaving the parties free to converse as desired.

In one suitable alternate embodiment, one or more of the notes or memos stored in the DB 24 may also be associated with a particular date and/or time in addition to designated telephone numbers. Accordingly, the PNS 20 is only triggered to deliver the corresponding note or memo when the subscriber 10 makes or receives a call from the associated telephone number at or about the time and/or date indicated in the DB 24. In this alternate embodiment, the times and/or dates in question may optionally be set by the subscriber 10 during the provisioning phase of the PNS operation. For example, suitable prompts and responses may optionally be provided and/or collected via the IVR unit 22.

Conceptually, time and/or date sensitive entries and/or records in the DB 24 optionally takes the following form:

User ID: (123) 456-7890

| Number | Date | Note/Memo |
|---|---|---|
| 222-3344 | May 5^{th} | Audio data or file for note N1 (e.g., “Joe's |
| | | Birthday”) |
| 222-3344 | June 19^{th} | Audio data or file for note N2 (e.g., “Joe's |
| | | Wedding Anniversary”) |
| . . . | . . . | . . . |
| 221-3221 | July 6^{th} | Audio data or file for note n (e.g., “Mike's |
| | | annual golf outing at XYZ Golf Club”) |

In the illustrated example, the user ID again identifies the subsequent records as belonging to a particular subscriber—in this example, the subscriber having the telephone number (123) 456-7890. Additionally, each record associates a particular telephone number (e.g., 222-3344, 221-3221, etc.) with a particular note or memo (e.g., note N1, note N2, etc.) that is also associated with a specific date. In any event, as can be appreciated, in the provisioning phase of operation, the subscriber 10 interacts with the PNS 20 to build and/or otherwise manage the foregoing data and/or information in the DB 24, i.e., by the subscriber 10 providing the PNS 20 with the designated telephone numbers, dates and corresponding notes and/or memos.

Accordingly, during the execution phase of operation, when the subscriber 10 receives a call from or make a call to a designated telephone number list in the DB 24 under their user ID at or about the time or date associated with the particular record, then the PNS 20 delivers the associated note or memo to the subscriber 10 prior to connecting the call with the other party, i.e., the party to whom the designated telephone number belongs.

For example, assume that the subscriber 10 (having telephone number (123) 456-7890) makes a telephone call to or receives a telephone call from the number 222-3344, i.e., the telephone number belonging to Joe in this case. Suitably, the PNS 20 intercepts the call upon recognizing that the originating or terminating telephone number (i.e., (123) 456-7890) identifies the subscriber 10. Accordingly, the PNS 20 quires the DB 24 under the subscriber's user ID to determine if the called number or calling number (i.e., 222-3344) is listed therein. In this example, the called or calling number is in fact listed twice in the records under the subscriber's user ID. Additionally, the PNS 20 also checks the corresponding date in the DB 24 to determine if it matches or is within some set tolerance of the current date. Provided the current date sufficiently matches the designated date in the DB 24 for a particular record, then PNS 20 selects the corresponding note or memo for playback or delivery to the subscriber 10 prior to connecting the call with the subscriber 10. In this case for example, if the call takes place on or about May 5^{th}, then prior to connecting the call between the subscriber 10 and Joe, the PNS 20 plays and/or otherwise delivers the note in the DB 24 associated with the designated telephone number and date (i.e., note N1 in this case) to the subscriber 10. Alternately, if the call takes place on or about June 19^{th}, then prior to connecting the call between the subscriber 10 and Joe, the PNS 20 plays and/or otherwise delivers the note in the DB 24 associated with the designated telephone number and date (i.e., note N2 in this case) to the subscriber 10. Of course, if the call takes place on some other date, the PNS 20 may play or deliver no note or memo to the subscriber 10 insomuch as no suitable date match was found. In this manner, before having to engage in conversation with Joe, the subscriber 10 is reminded of timely personal information about Joe, i.e., that it is his birthday or his wedding anniversary as the case may be depending on when the call takes place.

While certain examples are used herein for the purpose of describing the operation and/or implementation of the PNS 20, it is to be realized, however, that the emphasis of the current specification is not on the internal data structures and/or representations or the different ways individual subscribers may utilize the PNS 20. Rather, that which is of interest is the association of particular notes and/or memos with specific phone numbers or other like addresses and having this information stored or otherwise available in the network 30 in order to automatically provide to the subscriber a quick summary of relevant personal information and/or facts about the other party at or near the time of making or receiving a call, but nevertheless prior to having to engage in the ensuing conversation. In particular, for service provided on the originating side of the basic call model described above (e.g., which is extensible to 3G (3^{rd} Generation) as well as IMS and other networks also), the call origination from the subscriber 10 is trapped for a quick analysis and a specialized resource function (SRF) provides an audible announcement that reads out the stored notes to the subscriber 10 before the call is allowed to proceed to completion. Similarly, for service provided on the terminating side of the basic call model described above (again, which is extensible to 3G as well as IMS and other networks), the call termination attempt triggers service invocation, in which an SRF is instructed by the PNS 20 to provide call-specific announcements to the called party before proceeding with call establishment.

As can be appreciated from reading and understanding the present specification, some notable advantages of the PNS 20 include but are not limited to:
Ease of use, with no complicated set up having to be performed to implement the service in a service provider network;
In most cases, existing network elements suffice for implementing the service in a service provider network;
A subscriber may employ the service without having to have any specialized customer premise equipment (CPE);
Service usage is ubiquitous, that is to say, no specific phone type has to be employed for service execution; and,
Central storage of the notes or memos in the service provider's network permit the notes and/or memos to be played-back or otherwise delivered in real-time to the subscribers without the subscribers having to separately access other memory aids when a call is made or received. Central storage also offers the advantage that when user devices or equipments are upgraded or changed, a user does not have to modify the storage; rather, the notes continue to apply to the new device.

As indicated earlier, in one suitable embodiment, the PNS 20 is implemented in an IMS network. Accordingly, an example of such an implementation will now be described. Nevertheless, it is to be appreciated that the service can also be implemented in pre-IMS and other wireless and/or wireline networks equally well.

Please note, in the subsequent description and/or related figures, one or more following acronyms may be used in addition to those identified elsewhere in the present specification:
3GPP—3^{rd} Generation Partnership Project
3GPP2—3^{rd} Generation Partnership Project 2
AAA—Authentication/Authorization/Accounting
AS—Application Server
BGCF—Breakout Gateway Control Function
CSCF—Call Session Control Function
   I-CSCF—Interrogating CSCF
   S-CSCF—Serving CSCF
   P-CSCF—Proxy CSCF
HSS—Home Subscriber Server
IFC—Initial Filter Criteria
MGCF—Media Gateway Control Function
MGW—Media Gateway
MRFC—Media Resource Function Controller
MRFP—Media Resource Function Point
OSA—Open Service Architecture
PDF—Policy Decision Function
PDN—Public Data Network
PDS—Packet Data Subsystem
PLMN—Public Land Mobile Network
PSTN—Public Switched Telephone Network
RAN—Radio Access Network
RTP—Real Time Protocol
RTSP—Real Time Streaming Protocol
SCS—Service Capability Server
SDP—Session Description Protocol
SIP—Session Initiation Protocol

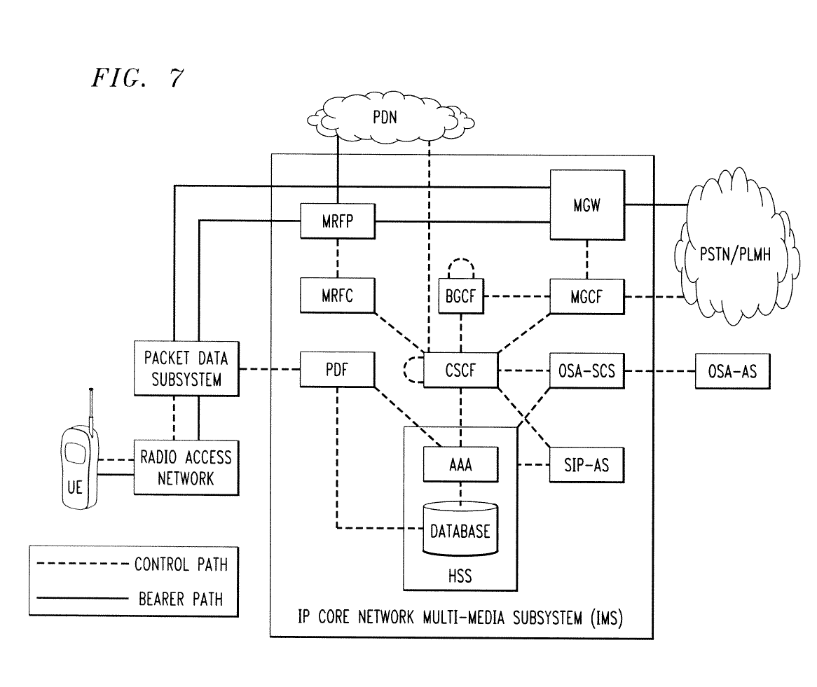

With reference now to FIG. 7, there is shown the 3GPP/3GPP2 harmonized architecture for IMS, and suitably, the PNS is configured as an application running on the SIP-AS. While FIG. 7 is provided herein for reference purposes, the general make-up and/or operation of the IMS is generally outside the scope of the present specification. Moreover, the general make-up and/or operation of a conventional IMS will be generally known to persons of ordinary skill in the art. Accordingly, no further detailed explanation of the IMS or its operation will be provided herein except to the extent appropriate for describing by way of example how the PNS may be implemented therein.

Suitably, to place the PNS in operation within the network and/or otherwise provision the service, the procedure followed is the same as for other services. In particular, a service subscription is indicated by including an IFC which is defined in the HSS. In practice, the HSS contains information about all the services and/or permissions a particular subscriber has, and the HSS is consulted when the subscriber originates a call, or prior to a call termination to this subscriber. Accordingly, the PNS suitably appears, in this case, in the IFC.

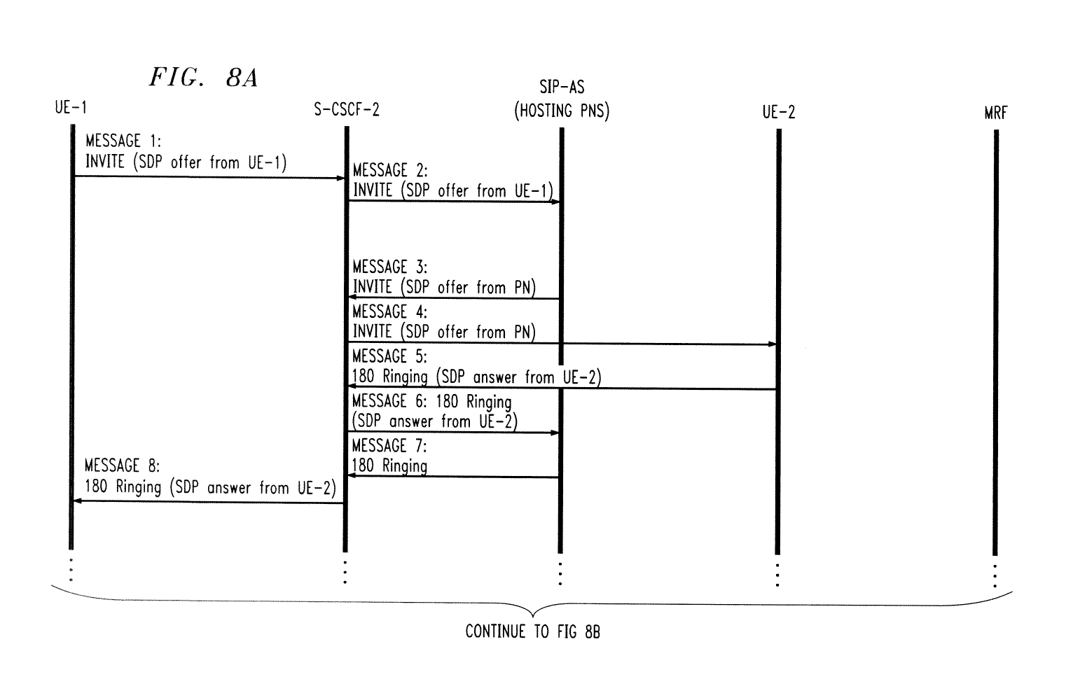

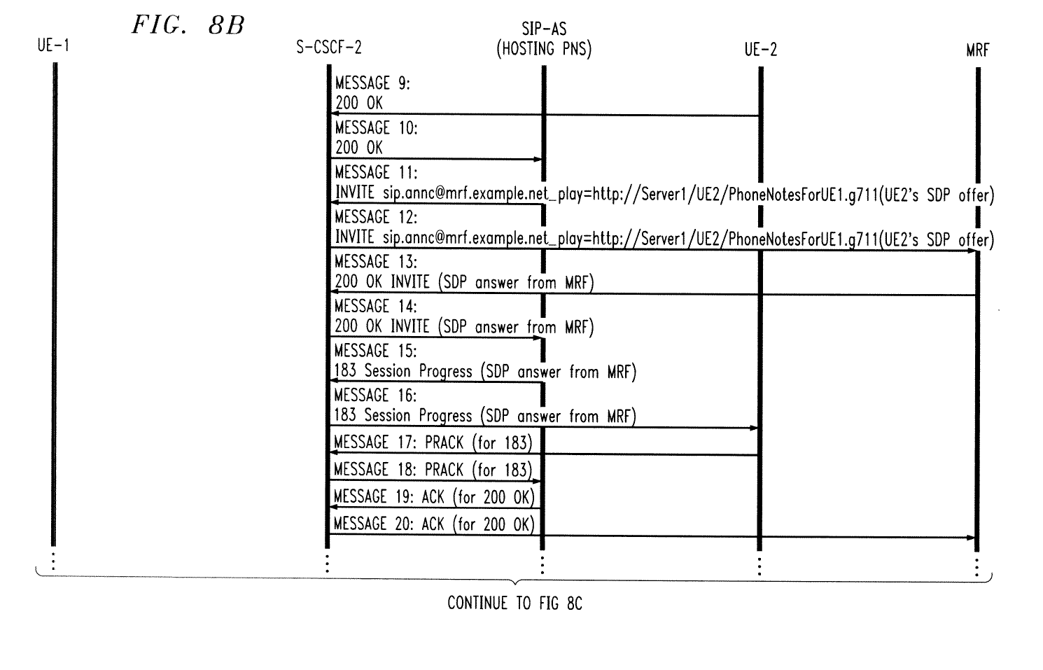

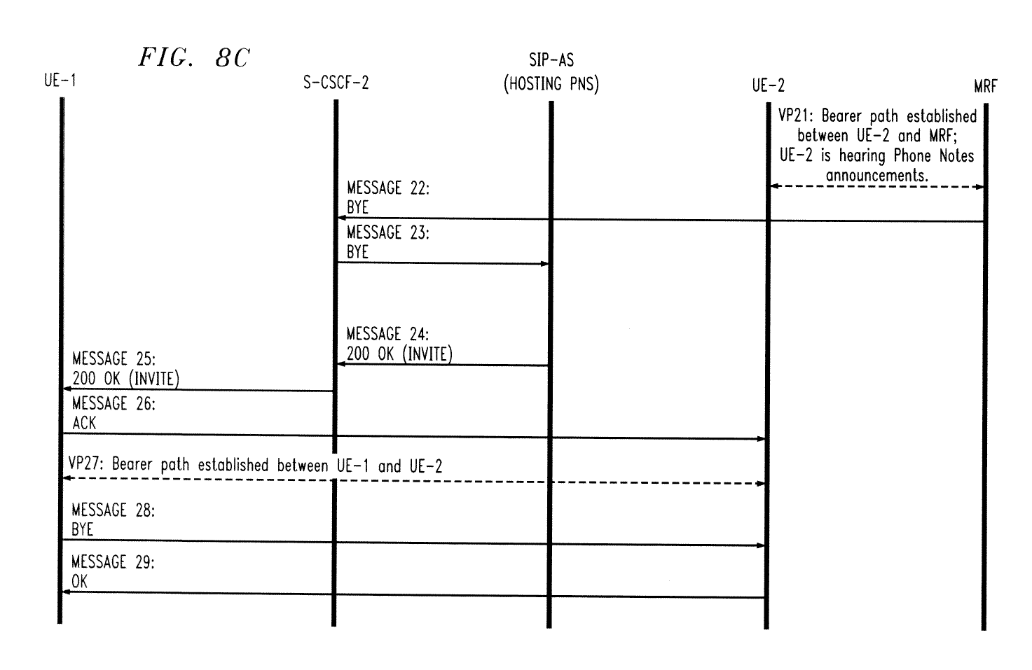

As indicated earlier, the PNS can be provided on the originating side (i.e., where the subscriber is the calling party), or terminating side (i.e., where the subscriber is the called party) or both. While all three scenarios are contemplated and readily achievable via suitable implementation within the IMS environment, describing all three scenarios herein would be unduly cumbersome. In any event, as between the originating side and the terminating side, perhaps the more complex part is describing the service on the terminating side. Accordingly, without losing generality, a terminating side service example will be described herein with reference to FIGS. 8A-8C. Nevertheless, upon reading and understanding the present example, persons of ordinary skill in the art will be able to appreciate and/or understand how to implement the service to support originating side operation as well as operation on both sides.

With reference to FIGS. 8A-8C, for purposes of this example, it is assumed that UE-1 (representing the calling party) is making a call to UE-2 (representing the called party). It is also assumed that the called party (i.e., the PNS subscriber in this case—represented by UE-2 in FIGS. 8A-8C), has recorded (e.g., via the IVR unit 22 shown in FIG. 1) a note or memo that is stored in the DB 24 for when the calling party (represented by UE-1 in FIGS. 8A-8C) calls. That is to say, e.g., during the provisioning phase of operation as described above with references to FIGS. 1 and 2, the PNS subscriber (i.e., UE-2 in this case) provided the PNS 20 the desired note or memo and the telephone number of the party with which the note is to be associated, i.e., the calling party UE-1 in this case. Accordingly, both the note and associated telephone number are now stored in the DB 24. It is further assumed for purposes of this example that the PNS 20 has stored this particular note or memo as a private audio file or data for the subscriber UE-2 in a the DB 24 and that the name of this audio file is “PhoneNotesForUE1.g711,” where the filename extension indicates the CODEC (coder/decoder) used for recording the note.

Since the terminating side of the PNS operation is described here (i.e., with the called party being the service subscriber), the illustrated message flow does not include network elements and/or interactions prior to the appearance of the call instance on the called party side. In an IMS network, this typically entails registration of the UE-1 and UE-2 with their respective networks, having the S-CSCF download the IFC from the HSS, and assigning an IP address to the UE for communication. As persons of ordinary skill in the art will appreciate, this is a standard operation, and suitably, the currently described implementation does not make any modification in the registration and authentication process steps.

As previously indicated, the following description provides an example of execution steps suitable for implementing the PNS on the terminating call side—that is to say, in the present example, the called party is shown as a service subscriber that gets to hear the particular note or memo in real-time when a specific calling party associated with the note or memo calls the called party.

Referring now to FIGS. 8A-8C, the illustrated sequence of messages and/or shots depict a call flow for the PNS execution phase of the present example, and in the following description the numbered steps correspond to like numbered messages and/or shots illustrated in FIGS. 8A-8C.

Initially, it is noted that the present exemplary scenario illustrates the PNS as a terminating side service. Accordingly, the interaction between UE-1 and the CSCFs on the originating side is not shown or described. Moreover, as will be appreciated from the following description, a bearer path is established between the called party (UE-2), a PNS subscriber, and the MRF, prior to establishing a call made to UE-2 from UE-1. Additionally, P-CSCF and I-CSCF elements are not shown here in the interest of brevity. Nevertheless their participation and/or role will still be appreciated and/or understood by persons of ordinary skill in the art. In particular, it will be appreciated that messages sent or received by a UE generally travel through a dedicated P-CSCF, and INVITE requests will travel through an I-CSCF when the target S-CSCF is not yet known. Finally, in some instances, it is possible for the UE-1 and UE-2 to be served by the same CSCF, in which case, the calling and called CSCFs may merge or otherwise be one in the same.

Step 1) UE-1 initiates the call, which appears on the terminating side at the S-CSCF-2 as a SIP INVITE with associated SDP information.

Step 2) Based on the IFC for UE-2, the S-CSCF-2 forwards the SIP INVITE to the SIP-AS hosting and/or running the PNS application. As can be appreciate, the SIP-AS serving the called party (i.e., UE-2) may perform additional telephony services. In this case, however, it is assumed that call barring is not turned on and the INVITE is in fact sent to the endpoint.

Steps 3-8) The application server alerts the called party (UE-2) and exchanges the SDP. Once the called party device sends back indication of ringing in step 7, the SIP-AS reflects this to the calling party (UE-1) in step 8. When UE-1 receives this message, it provides (local) ringing to the calling party.

Steps 9 & 10) These steps show that the UE-2 has gone off-hook (step 9) in response to the SIP INVITE sent in step 3 and this indication is provided to the SIP-AS (step 10).

At this point, the AS has determined that UE-2 has enabled the PNS. In this example, the PNS is active, so an INVITE will be sent to the MRF. The MRF will receive pointers to announcements (i.e., selected notes and/or memos) to be played or otherwise delivered to the UE-2 prior to establishment of the call between UE-1 and UE-2. Of course, if there are no announcements pending or selected (i.e., no notes or memos meeting the search criteria or associate with the other party's telephone number in the DB 24), then the INVITE will not go out to the MRF and call completion will proceed as usual with PNS dropping out of call processing completely. However, in this example, there is a note or memo associated in the DB 24 with the telephone number of UE-1, i.e., the calling party. Accordingly, an announcement including the particular note or memo will indeed be played or otherwise delivered to UE-2.

Steps 11 & 12) Here, the PNS application, invokes the MRF functionality to play the call-specific note for the called party. For example, the PNS identifies the note or memo to deliver to UE-2 by looking in the DB 24 under the subscriber's user ID for a telephone number matching that of the other party, i.e., UE-1 in this case, and accordingly the PNS 20 selects the note or memo in the corresponding record. Typically, MSCML (Media Server Control Markup Language) and/or Netann (Network Announcement) protocols are used for involving the MRF from the AS side. In this simplified example, “sip:annc” indicates that an announcement is to be played by the media server identified by “mrf.example.net” and the URI for the announcement is “Server1/UE2/PhoneNotesForUE1.g711”, which is to be fetched via “http”. Recognize that the file name containing the note or memo for this call, as indicated earlier, is PhoneNotesForUE1.g711. Moreover, this exemplary URI shows that each subscriber has a subscriber-specific area or file path for storing caller-specific announcements. In practice, however, a suitable implementation can use any hashing/indexing/bucketing or other appropriate scheme to optimize storage.

Also note that the SDP from UE-2 is carried as an offer to the MRF in these steps. The SDP provides the portmap for the MRF to play the announcement indicated by the Netann payload in the SIP INVITE in these steps.

Steps 13 & 14) The MRF responds to the SDP and indicates that it is willing to provide the announcement function for playback of the selected note or memo.

Steps 15 & 16) The application server initiates an Early Media session towards UE-2 (notice that the call has not yet been established for UE-2).

Steps 17 & 18) UE-2 responds by sending a reliable provisional acknowledgment via a PRACK message.

Steps 19 & 20) At this stage, the application knows that MRF is ready to send early media and that UE-2 is ready to receive this early media. Hence, it signals the MRF, via the 200 OK message to initiate media play.

Step 21) An end-to-end bearer path is established between the MRF and UE-2 (note that MRF has the portmap information for UE-2, as conveyed in the SDP from the PNS application server in the SDP sent to the MRF in steps 11 and 12).

Steps 22 & 23) Upon termination of the announcement playback, the MRF initiates a tear-down by sending a BYE. In practice, the actual announcement playback to UE-2 (step 21) typically will not exceed some limited time period, insomuch as UE-1 is waiting for call establishment to UE-2.

At this point, UE-2 has heard the delivered note or memo and it is now time to establish the call between the UE-1 and UE-2. Notice that the MRF is out of the conversation after playing the announcement containing the note or memo. Also, UE-1 has the SDP Answer containing UE-2's SDP. The PNS also has a 200 OK from UE-2, so call establishment between UE-1 and UE-2 is greatly simplified.

Step 24 & 25) Here, since the SDP offer-answer has completed (see step 8), the AS sends a 200 OK that is sent back to the UE-1.

Step 26) UE-1 acknowledges the 200 OK via an ACK.

Step 27) An end-to-end bearer path is now established between UE-1 and UE-2.

Steps 28 & 29) Once the conversation is over, UE-1 or UE-2 can initiate the call tear-down, where a BYE is sent from one of the devices (here, UE-1 is shown to send the BYE in step 28) and then the other device sends an OK to the BYE (here, UE-2 is shown to send the OK in step 29).

It is to be appreciated that in connection with the particular exemplary embodiments presented herein certain structural and/or function features are described as being incorporated in defined elements and/or components. However, it is contemplated that these features may, to the same or similar benefit, also likewise be incorporated in other elements and/or components where appropriate. It is also to be appreciated that different aspects of the exemplary embodiments may be selectively employed as appropriate to achieve other alternate embodiments suited for desired applications, the other alternate embodiments thereby realizing the respective advantages of the aspects incorporated therein.

It is also to be appreciated that particular elements or components described herein may have their functionality suitably implemented via hardware, software, firmware or a combination thereof. Additionally, it is to be appreciated that certain elements described herein as incorporated together may under suitable circumstances be stand-alone elements or otherwise divided. Similarly, a plurality of particular functions described as being carried out by one particular element may be carried out by a plurality of distinct elements acting independently to carry out individual functions, or certain individual functions may be split-up and carried out by a plurality of distinct elements acting in concert. Alternately, some elements or components otherwise described and/or shown herein as distinct from one another may be physically or functionally combined where appropriate.

In short, the present specification has been set forth with reference to preferred embodiments. Obviously, modifications and alterations will occur to others upon reading and understanding the present specification. It is intended that the invention be construed as including all such modifications and alterations insofar as they come within the scope of the appended claims or the equivalents thereof.

What is claimed is:

1. In a telecommunications network, a method for providing a first party personal information about a second party prior to completing establishment of a call between the parties over the network, said method comprising:
(a) storing a number of records for the first party in a location within the network, each record associating particular personal information related to a particular second party with an identifier corresponding to that particular second party;
(b) when a call is processed within the network for the first party, checking if an identifier of the second party to the call being processed matches an identifier in the location where the records are stored for the first party; and,
(c) if the identifier of the second party in the call being processed within the network does indeed match an identifier in the location where the records are stored for the first party, then playing an announcement to the first party including the personal information associated in the corresponding record with the matching identifier, said announcement being played to the first party prior to establishment of the call between the parties.

2. The method of claim 1, wherein the first party is a calling party with respect to the call being processed and the second party is a called party with respect to the call being processed.

3. The method of claim 1, wherein the second party is a calling party with respect to the call being processed and the first party is a called party with respect to the call being processed.

4. The method of claim 3, further comprising:
providing ring-back to the second party while the announcement is being played to the first party.

5. The method of claim 1, wherein the network includes an Internet Protocol Multimedia Subsystem in which the method is implemented.

6. In a telecommunications network, a system for providing a first party personal information about a second party prior to completing establishment of a call between the parties over the network, said system comprising:
means for storing a number of records for the first party in a location within the network, each record associating particular personal information related to a particular second party with an identifier corresponding to that particular second party;
when a call is processed within the network for the first party, means for checking if an identifier of the second party to the call being processed matches an identifier in the location where the records are stored for the first party; and,
means for playing an announcement to the first party including the personal information associated in the corresponding record containing the matching identifier, if the identifier of the second party in the call being processed within the network does indeed match an identifier in the location where the records are stored for the first party, said announcement being played to the first party prior to establishment of the call between the parties.

7. The system of claim 6, wherein the first party is a calling party with respect to the call being processed and the second party is a called party with respect to the call being processed.

8. The system of claim 6, wherein the second party is a calling party with respect to the call being processed and the first party is a called party with respect to the call being processed.

9. The system of claim 8, further comprising:
means for providing ring-back to the second party while the announcement is being played to the first party.

10. The system of claim 6, wherein the network includes an Internet Protocol Multimedia Subsystem in which the system is implemented.
